(19) United States
(12) Patent Application Publication
(10) Pub. No.: US 2015/0294236 A1
(43) Pub. Date: Oct. 15, 2015

(54) ELECTRONIC MISCELLANEOUS DOCUMENT HANDLING IN RESPONSE TO VOLUNTARY MODIFICATIONS OF ANCILLARY SERVICES

(71) Applicant: Amadeus S.A.S., Sophia Antipolis (FR)

(72) Inventors: Anatole Laffitte, Mouans Sartoux (FR); Bertrand Alberola, Pegomas (FR); Manuela Argano, Antibes (FR); Caroline Pellegrin, Mouans Sartoux (FR); Garnier Ngando, Nice (FR)

(73) Assignee: Amadeus S.A.S., Sophia Antipolis (FR)

(21) Appl. No.: 14/252,801

(22) Filed: Apr. 15, 2014

(51) Int. Cl. G06Q 10/02; G06Q 50/14; G06Q 30/02

(52) U.S. Cl. CPC G06Q 10/02; G06Q 30/0283; G06Q 50/14

(57) ABSTRACT

Methods, systems, and computer program products for handling electronic miscellaneous documents in response to voluntary modifications of services. A request, which includes first data for a passenger name record, is received for the airline reservation change. Second data for a first electronic miscellaneous document, which is linked to the first data for the passenger name record, is also received. A determination is made as to whether the first electronic miscellaneous document can be exchanged by applying at least one exchange eligibility rule to the first and second data. If the first electronic miscellaneous document can be exchanged, a fare for a service associated with the first electronic miscellaneous document is obtained from a pricing engine associated with the first electronic miscellaneous document. In response to receiving the fare for the service, the passenger name record is updated with a second electronic miscellaneous document including the fare for the service.

### BACKGROUND

The invention generally relates to computers and computer software and, in particular, to methods, systems, and computer program products for handling the exchange of electronic miscellaneous documents in response to voluntary modifications of services.

Electronic miscellaneous documents (EMDs) are issued for travel-related services, including unbundled airline services. Generally, two distinct types of electronic miscellaneous documents may be issued. A standalone electronic miscellaneous document (EMD-S) is not issued in conjunction with a standard flight ticket. A standalone electronic miscellaneous document can be issued for a non-flight ancillary service, such as a car rental voucher or lounge access, but is not associated to a flight coupon. An associated electronic miscellaneous document (EMD-A) can be issued for an ancillary service, such as excess checked baggage, sports equipment, premium seats, or a meal or beverage. An associated electronic miscellaneous document is directly associated to a flight coupon for a flight segment.

A customer may elect to change one or more initially-planned ancillary services or to exchange a flight ticket to which an electronic miscellaneous document is associated. Such customer-initiated voluntary changes involve modifications to an original electronic miscellaneous document that was issued for the customer. A travel agency that issued the issuance of the original electronic miscellaneous document may handle the voluntary change and provide the customer with a new document validating the modification to the electronic miscellaneous document. A travel agent may manually update the electronic miscellaneous document through a series of long, complex, and error-prone operations that require a high knowledge of service pricing combined with knowledge of exchange use cases. Many parameters, such as the price of a service, balance, tax, etc., may be impacted by a voluntary change request and must be redetermined in accordance with the requested change. A new pricing record may be created that contains a reference to the original document and information about each new service.

The re-pricing of an electronic miscellaneous document is relatively complex in comparison with the re-pricing of a flight ticket. Among other reasons, the price of a new electronic miscellaneous document depends, among other parameters, on the price of the services at exchange time, the price of the electronic miscellaneous document to be exchanged, and the price of the new flight ticket, if any, to which the new electronic miscellaneous document will be associated. Therefore, the checks on eligibility, the determination of a new price, the deduction of old amounts remaining in the electronic miscellaneous document to be exchanged, the creation of a pricing record with a proper original document reference, and management of any penalty and residual value represent some of the time-consuming and error-prone steps taken by a travel agent.

Improved methods, systems, and computer program products are needed to handle exchanges of electronic miscellaneous documents in response to voluntary modifications of services.

### SUMMARY

Embodiments of the invention generally comprise methods, systems, and computer program products for responding to a change in an airline reservation. A request, which includes first data for a passenger name record, is received for the change to the airline reservation. Second data for a first electronic miscellaneous document, which is linked to the first data for the passenger name record, is also received. A determination is made as to whether the first electronic miscellaneous document can be exchanged by applying at least one exchange eligibility rule to the first data for the passenger name record and the second data for the first electronic miscellaneous document. If the first electronic miscellaneous document can be exchanged, a fare for a service associated with the first electronic miscellaneous document is obtained from a pricing engine associated with the first electronic miscellaneous document. In response to receiving the fare for the service, the passenger name record is updated with a second electronic miscellaneous document including the fare for the service.

### BRIEF DESCRIPTION OF THE SEVERAL VIEWS OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a diagrammatic view of an exemplary operating environment including a plurality of computer systems.

FIG. 2 is a diagrammatic view of an exemplary computer system of FIG. 1.

FIG. 3 is a block diagram of an exemplary service changer system in accordance with an embodiment of the invention.

FIGS. 4A and 4B is a flow chart of a process performed at the input analyzer component in accordance with an embodiment of the invention.

FIG. 5 is a sequence diagram in accordance with an embodiment of the invention.

FIG. 6 illustrates the data provided by the different components and databases for the determination of a new pricing record.

FIG. 7 illustrates a passenger name record before a voluntary change rebooking and after the voluntary change rebooking.

FIGS. 8A and 8B illustrate an electronic miscellaneous document before a voluntary change rebooking and after the voluntary change rebooking that is associated to the passenger name record of FIG. 7.

### DETAILED DESCRIPTION

Embodiments of the invention are generally directed to service changer systems, methods, and computer program products to automatically handle the updating of electronic miscellaneous documents in response to passenger-initiated voluntary changes to ancillary services in airline reservations or to flight tickets to which electronic miscellaneous documents are associated. The service changer system may perform complex transactions by collecting data from a variety of different sources, and then adapting and aggregating the collected data into a single record to simultaneously process in a single query one or more changes of electronic miscellaneous documents for several passengers. The service changer system provides a flexible layout within a user graphical user interface that permits the services impacted by the changes to be identified and the related documents to be exchanged. A travel agent can perform only a partial selection (or no selection at all) of the services, the electronic miscellaneous documents, and the passengers to which each exchange is applied. By automatically analyzing the associations between all the elements in context, any information that has not explicitly been entered by the travel agent can be automatically inferred. The service changer system may operate with a variety of pricing engines by providing an interface that adapts queries to the specificities of each individual pricing engine.

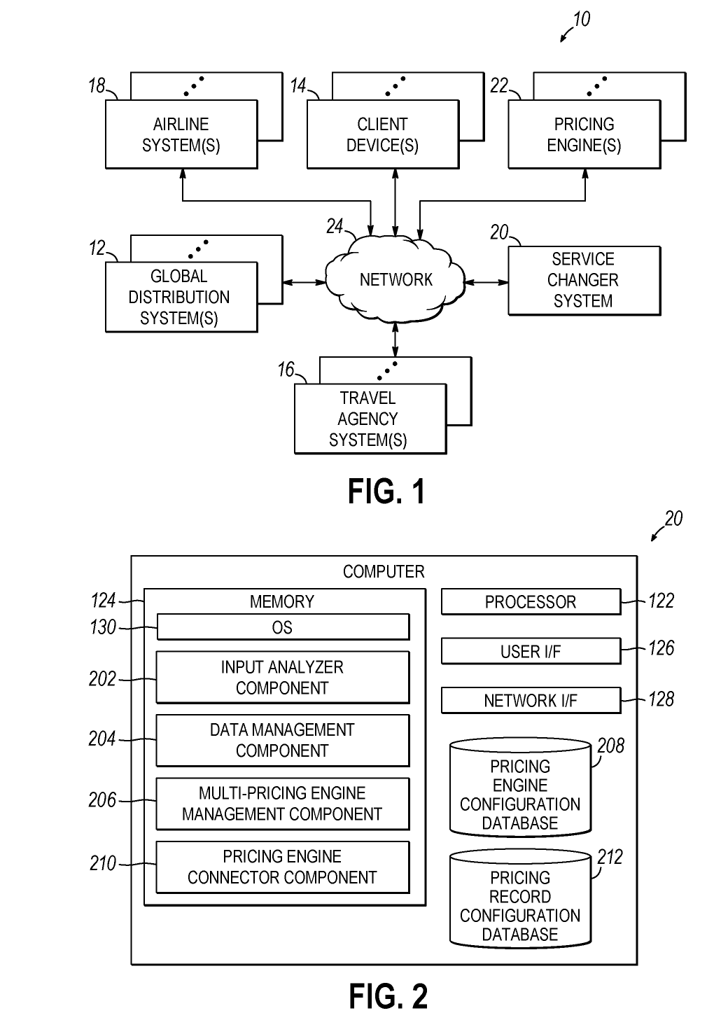

With reference to FIG. 1, an operating environment 10 may include one or more Global Distribution Systems (GDS) 12, one or more client devices 14, one or more travel agency systems 16 constituting indirect seller systems, one or more airline systems 18 constituting carrier systems, a service changer system 20, and one or more pricing engines 22. The GDSs 12, client devices 14, travel agency systems 16, airline systems 18, service changer system 20, and pricing engines 22 may be coupled to a network 24. The network 24 may include one or more private and/or public networks (e.g., the Internet) that enable the exchange of data.

Each GDS 12 may be configured to facilitate communication between the travel agency systems 16 and the airline systems 18 by enabling travel agents, validating carriers, or other indirect sellers to search for available travel products and book reservations on one or more of the airline systems 18 via the GDS 12. To this end, each GDS 12 may maintain a communication link to each airline systems 18 via the communication network 24. These communication links may allow the GDS 12 to obtain scheduling and availability data for travel products from the airline systems 18. Each travel agency system 16 may thereby book flights, as well as trains, hotels, rental cars, or other travel products, from multiple service providers via a single connection to the GDS 12.

In response to a travel product being booked, the GDS 12 may receive and store information about the travel product in a passenger name record (PNR). The PNR may be generated, at least in part, by the airline systems 18, and may comprise one or more reservation records comprised of segments and traveler data associated with one or more booked reservations. PNR segments may be identified, for example, as active (e.g., for a service yet to be provided by the corresponding service provider), passive (e.g., for a service reserved in another system or provided by a third party), past date, flown, information, open (e.g., for a purchased service having an open date), or canceled. The PNR may be stored in a database accessible to GDSs 12, airline systems 18, travel agency systems 16, and service changer system 20. The PNR may be identified by a record locator unique to each PNR, and may include segments defining an itinerary for a particular trip, service, passenger, or group of passengers. The itinerary may include services from multiple carriers (e.g., flights, bus, and or rail segments), hotel reservations, rental car reservations, or any other travel-related services.

Each airline system 18 may include a computer reservation system (CRS) and/or billing system for the respective service provider. The CRS may enable each GDS 12 and/or each travel agency system 16 to reserve ticketed services, such as flights, rail services, hotel rooms, or rental cars, as well as ancillary services associated with the ticketed services. Each airline may own and operate airport ticket offices (ATO) and city ticket offices (CTO) to sell tickets for themselves and/or other airlines. The pricing engines 22 may be hosted at the airline systems 18 or at the GDSs 12, but each is associated with a particular airline. Each airline system 18 may include a reservation system that enables airline ticketing offices, the GDSs 12, and/or the travel agency systems 16 to find, book, and pay for airline tickets.

Each travel agency system 16 may include a server application, such as a web server, that provides a publicly accessible website. This website may be configured to provide access to travel planning features, such as the ability to search for travel products matching a travel request. To this end, each travel agency system 16 may be configured to provide the traveler with access to data from one or more databases hosted by the GDS 12, travel agency systems 16, and/or airline systems 18.

Each client device 14 may be any suitable computing system configured to communicate over the network 24. Each client device 14 may comprise a desktop, laptop, or tablet computer, a smart phone, a personal digital assistant, or any other mobile or fixed computing device that enables the traveler to search for and book travel services over the network 24. For example, each client device 14 may include a client application, such as a web-browser, that communicates with a server application hosted by one of the travel agency systems 16, such as a web-server. The server application may, in turn, communicate with the GDS 12, travel agency systems 16, and/or airline systems 18 to obtain data relating to available travel services so that a traveler may book travel services and be issued electronic documents.

The GDS 12 may access one or more document databases to store and retrieve data relating to electronic tickets or other electronic documents associated with a purchased service. The service changer system 20, which may be hosted by, e.g., a GDS 12 or an airline system 18, may be configured to handle the exchange of electronic miscellaneous documents (EMDs) in response to voluntary passenger modifications to a reservation. The service changer system 20 may be provided by an airline IT solution provider that also provides a network infrastructure for the operating environment 10, and that may offer, among others, hardware and software components for online transactions involving sales tickets and ancillary services. All or a portion of the service changer system 20 may be integrated into one or more of the other systems, such as one of the GDSs 12.

Each EMD may comprise one or more electronic coupons stored in a document database accessible to at least the service changer system 20, with each coupon corresponding to a service provided by the EMD. In response to one or more of the electronic coupons being used, exchanged, or refunded, the document database may be updated to reflect a change in status of the electronic document.

FIG. 2 provides a block diagram that illustrates the components of the one or more servers of a computer system that may comprise the service changer system 20 in accordance with an embodiment of the invention. The service changer system 20 may receive and process a request for a voluntary change that is generated and triggered either by a direct or an indirect channel, i.e. through an airline website via one of the client devices 14 or from a cryptic terminal or a GUI terminal at one of the travel agency systems 16.

The service changer system 20 includes at least one processor 122 including at least one hardware-based microprocessor and a memory 124 coupled to the at least one processor 122. The memory 124 may represent the random access memory (RAM) comprising the main storage of the service changer system 20, as well as any supplemental levels of memory, e.g., cache memories, non-volatile or backup memories (e.g., programmable or flash memories), read-only memories, etc. In addition, memory 124 may be considered to include memory storage physically located elsewhere in the service changer system 20, e.g., any cache memory in a microprocessor, as well as any storage capacity used as a virtual memory, e.g., as stored on a mass storage device or on another computer coupled to the service changer system 20.

For interface with a user or operator, the service changer system 20 may include a user interface 126 incorporating one or more user input/output devices, e.g., a keyboard, a pointing device, a display, a printer, etc. Otherwise, data may be communicated to and from another computer or terminal (e.g., GDSs 12, client devices 14, travel agency systems 16, airline systems 18, and pricing engines 22) over a network interface 128 coupled to the communication network 24. The service changer system 20 also may be in communication with one or more mass storage devices, which may be, for example, internal hard disk storage devices, external hard disk storage devices, external databases, storage area network devices, etc.

The service changer system 20 typically operates under the control of an operating system 130 and executes or otherwise relies upon various computer software applications, components, programs, objects, modules, engines, data structures, etc. In particular, the components may include an input analyzer component 202, a data management component 204, a multi-pricing engine manager component 206, and a pricing engine connector component 210, and may comprise instructions that may be resident and/or stored in the memory 124.

The service changer system 20 may include one or more databases including, for example, a pricing engine configuration database 208 and a pricing record configuration database 212. Each of the databases 208, 212 may comprise data and supporting data structures that store and organize the data. In particular, each of the databases 208, 212 may be arranged with any database organization and/or structure including, but not limited to, a relational database, a hierarchical database, a network database, and/or combinations thereof. A database management system in the form of a computer software application executing as instructions on the processing unit of the service changer system 20 may be used to access the information or data stored in records of the databases 208, 212 response to a database query.

Moreover, various applications, components, programs, objects, modules, engines etc. may also execute on one or more processors in another computer coupled to the service changer system 20 via the communication network 24, e.g., in a distributed or client-server computing environment, whereby the processing required to implement the functions of a computer program may be allocated to multiple computers over a network. For example, some of the functionality described herein as being incorporated into the service changer system 20 and/or components of the service changer system 20 may be implemented in one or more servers. Consistent with embodiments of the invention, the components, modules, applications, and/or engines may be executing on one or more servers of the service changer system 20, and may cause the processor 122 of the service changer system 20 to perform operations consistent with embodiments of the invention.

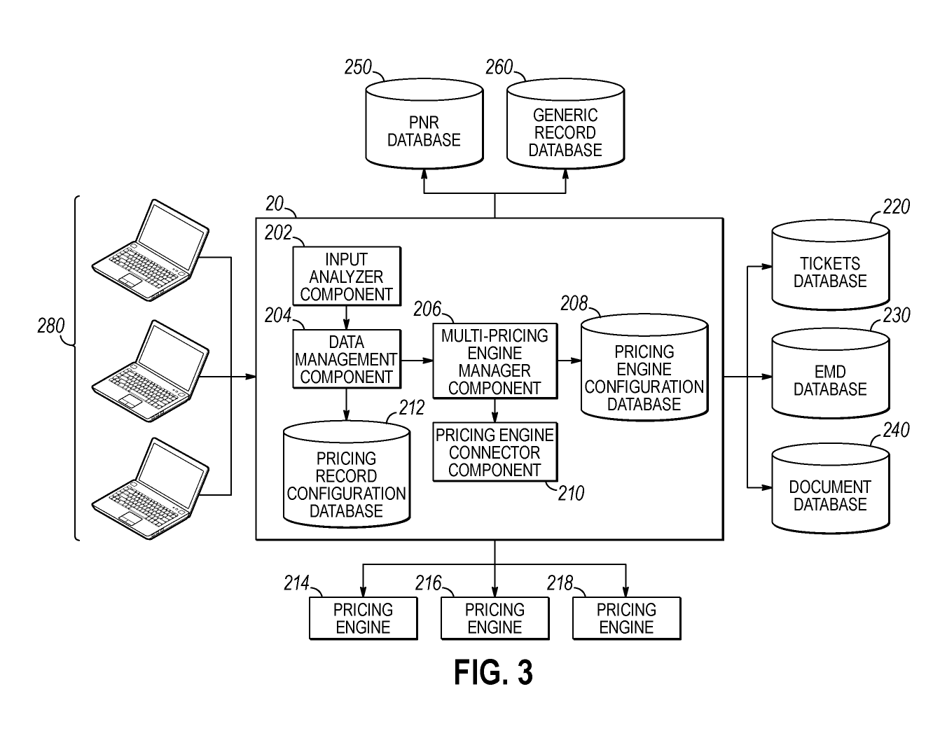

FIG. 3 depicts a block diagram of an embodiment of the service changer system 20. The service changer system 20 may be configured to perform the operations of handling a voluntary service change in response to a traveler or passenger deciding to request a change in his or her initial reservation. A voluntary change request is generated and triggered either by a direct or an indirect channel, i.e. through airline websites or GUI/cryptic terminals, which are collectively shown as client terminals 280. The service changer system 20 is coupled to various components having a variety of databases to store documents involved in the process, such as electronic tickets stored in a ticket database 220, EMDs stored in a EMD database 230, and generic documents stored in a document database 240, as well as information regarding reservations in the form of PNRs stored in a PNR database 250 or records of other types stored in a generic record database 260. The databases 220, 230, 240, 250, 260 may be similar in organization and structure to the pricing record configuration database 212 and pricing engine configuration database 208. The databases 220, 230, 240, 250, 260 may be hosted at one or more of the GDSs 12 and/or airline systems 18.

Each EMD stored in the EMD database 230 is an electronic document that may be issued in response to a traveler purchasing an ancillary service. The EMD can be consulted to determine whether the traveler is entitled to receive the ancillary service. Exemplary services for which EMDs may be issued include allowances to carry additional luggage, entitlements to enter special zones (e.g., a business lounge), receive a meal or a beverage during a travel segment (e.g., a flight), choose a specific seat (e.g., a window seat, an aisle seat, a seat with extra leg room, etc.), receive transportation services between an airport and a hotel, or receive premium in-flight services.

Each PNR stored in the PNR database 250 may include traveler data that provides details of a traveler's reservation, other data related to the traveler's trip, and data that assists airline personnel with passenger handling. Specific data typically found in the PNR may include the name of the traveler, a passenger type code, data identifying one or more reserved travel segments, contact information for the traveler, when and where tickets are to be issued, and the ticketing office or agent that made or updated the reservation. When an EMD is issued for an ancillary service, the PNR may be updated with data that associates the PNR with the EMD. The travel service provider may thereby associate the segments in the PNR with the EMD for the corresponding ancillary service purchased by the traveler.

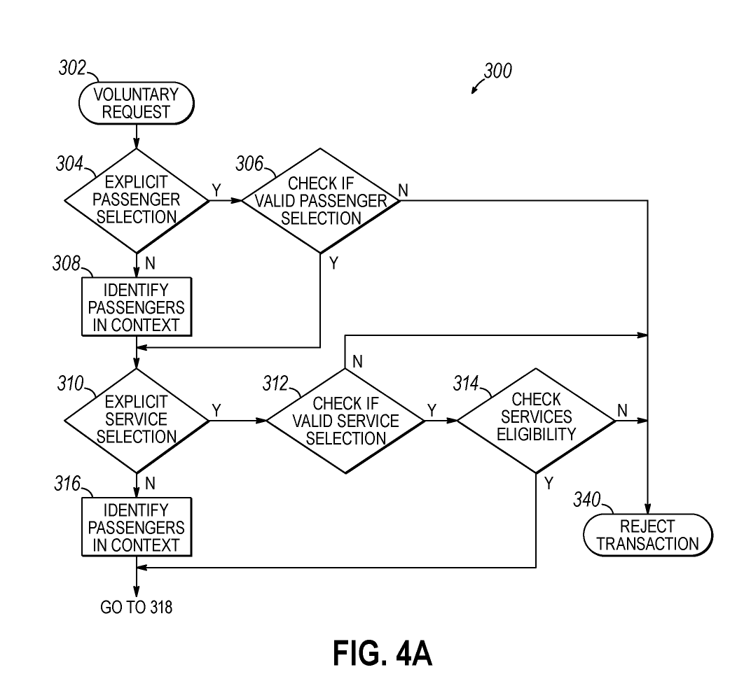

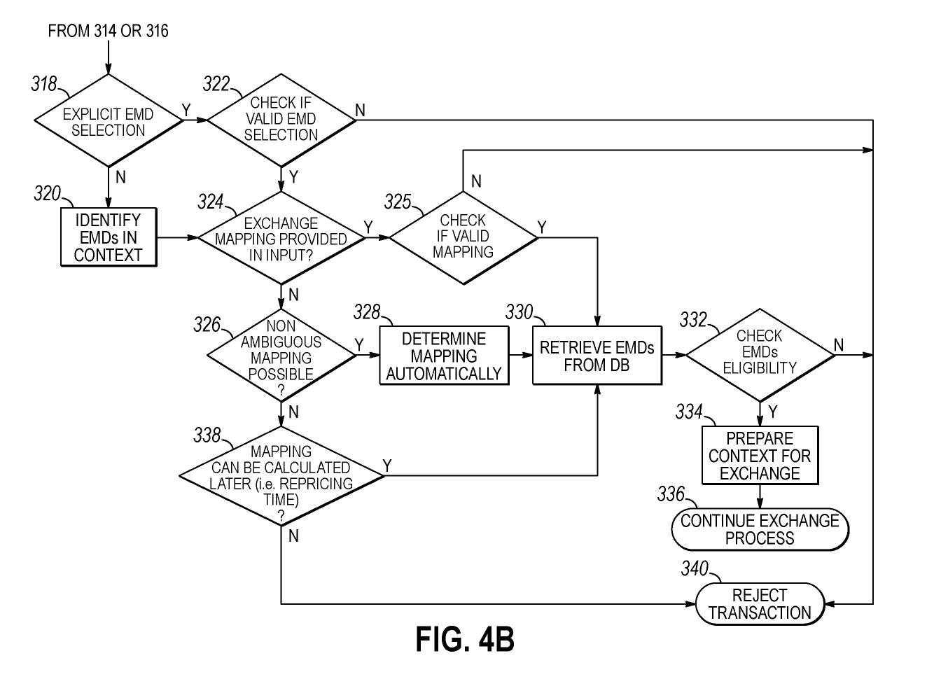

The service changer system 20 is further coupled to different pricing engines 214, 216, 218 that are configured to provide information on fares, as well as rules associated with the fares, in a format suitable for computer processing. The pricing engines 214, 216, 218 may be based on the Airline Tariff Publishing Company (ATPCO) or another heterogeneous external airline pricing system. The content and operating mode of the service changer system 20 is further discussed in conjunction with FIGS. 4-6.

The service changer system 20 includes the input analyzer component 202 configured to verify the validity of a voluntary change request. The input analyzer component 202 is configured to receive a voluntary change request from one of the client terminals 280. The request to be processed may require the performance of one or more exchanges, each of the exchanges from one or more EMDs to one or more services for a given passenger.

The information on the services to be included in the exchange can be either explicitly selected by the agent/passenger in the request or it can be automatically identified from the context of the change request by a process executed by the input analyzer component 202. Based upon the passenger name record, the input analyzer component 202 is configured to retrieve one or several original EMDs associated with the passenger airline reservation from the EMD database 230, and to determine that the voluntary change request is eligible for an exchange of the one or several original EMDs or, alternatively, to reject the request. The input analyzer component 202 is also configured to issue a notification to the client terminal originating the request to inform of the validation of the voluntary change request or of its rejection.

After a validity checking process 300 detailed below in FIGS. 4A and 4B, the voluntary change request is further processed by the data management component 204. Generally, the data management component 204 is in charge of several operations to generate a new pricing record linked to the passenger name record and to a new EMD including all the updates and prices for all the changes, as well as related fare elements required for issuance processing (original issue, endorsement, etc. . . . ). In addition to the pricing record that will constitute the basis for the reissued EMD, and depending on the repricing output, the data management component 204 may create a residual value record, that will result in a residual value of a specific amount that is not used in the exchange but that can be returned back to the passenger according to the airline rules and practices.

The data management component 204 is also coupled to a pricing record configuration database 212. The pricing record configuration database 212 stores pricing records configurations of different airlines.

The data management component 204 is further coupled to the multi-pricing engine manager component 206, which is in charge of collecting the PNR data and airlines rules information for selecting the correct pricing engine 214, 216, 218 corresponding to the EMD to handle. The multi-pricing engine manager component 206 is coupled to a pricing engine configuration database 208, which stores airline configuration rules, the elements, and parameters for allowing the selection of the pricing. For instance, an airline can be configured to always price its services through an ATPCO filing, while another airline may want its proprietary system to be the only one in charge of pricing for their services. An airline may also decide to price its services through ATPCO except, for instance, the class upgrade services, that according to its policy are priced in miles through their own specific systems.

The multi-pricing engine manager component 206 is further coupled to the pricing engine connector component 210 to interface with the pricing engines 214, 216, 218. The pricing engine connector component 210 allows formatting with the respective airline configuration rules, sends repricing queries to the pricing engines 214, 216, 218, and receives the responses with the computed fares from the queried pricing engines. The pricing engine connector component 210 also gathers the data obtained from each of the pricing engines 214, 216, 218 to organize them in a common model to be provided back to the data management component to finalize the exchange process.

FIGS. 4A and 4B show a process flow performed at the input analyzer component 202 in accordance with an embodiment of the invention. A voluntary change request is received by the service changer system 20 in block 302. All data required for the exchange process is gathered, including information on passengers and services impacted by the voluntary change. As described above, the input analyzer component 202 is in charge of verifying the validity of the requested exchange. The process automatically retrieves the missing information (through blocks 308, 316, 320, 328 of the process flow) if the change request does not define all the elements involved for the exchange.

After the receipt of the voluntary change request, the service changer system 20 determines in block 304 whether all the passengers for which the exchange has to be performed are identified in the request by appropriate passenger selections from the agent. If the passenger selections are clearly mentioned (branch Yes), the validity of the selection of passengers is checked in block 306. For example, if the passenger exists in the context and if the request is coherent in general with this context (e.g., in the request it is mentioned “pax infant 1” and if “pax 1” exists but for an adult), then the check fails. If the passenger selections are not valid, the service changer system 20 rejects the transaction (block 340). Otherwise, control is transferred by the service changer system 20 to block 310.

If the passenger selections are not mentioned in the request (branch No in block 304), all the passengers involved in the current context of the change are automatically retrieved by the service changer system 20 in block 308. Following the blocks (304, 306, 308) pertaining to the identification of the passengers, the validity of the change request is checked by the service changer system 20 at a services level by controlling several eligibility criteria.

In block 310, the service changer system 20 checks to determine whether the new services are mentioned in the request. If new services are mentioned, the validity of the services selections in the request, i.e., if the service exists in the context or if it is associated to the selected passenger, is checked by the service changer system 20 (block 312). If the services selections are not valid, the service changer system 20 rejects the transaction (block 340). Otherwise, the service changer system 20 transfers control to block 314.

In block 314, the eligibility of the selected services to voluntary changes is checked. If the services are not valid, the transaction is rejected (block 340). Otherwise, the service changer system 20 transfers control to block 318. Eligibility may be defined through several rules determining which services can be targeted by an exchange and which services cannot be targeted by an exchange. For instance, all if the ancillary services that cannot be priced may be excluded from exchange. Another eligibility rule can be based on the date of the ancillary service, where, for example, past-dated services are excluded from the exchange.

If the ancillary services are not explicitly selected in the request in block 310, the predefined eligibility criteria are used to filter services in the PNR, in order to discard the non-eligible services from the exchange process (block 316). Control is transferred by the service changer system 20 to block 318 as illustrated on FIG. 4B.

In block 318, a determination is made by the service changer system 20 whether the EMD(s) is/are explicitly defined in the request. If the EMD(s) is/are explicitly defined in the request, the service changer system 20 checks the validity of the EMD selections in the request (block 322). For example, the service changer system 20 checks whether the selection is done by a reference in the PNR; if the selection exists and corresponds to an EMD, or if the selection is an EMD number, then the service changer system 20 checks for the existence of the selection in the EMD database 230. If the EMD selections are not valid, the transaction is rejected (block 340). Otherwise, the service changer system 20 transfers control to block 324. In block 324, the service changer system 20 performs a test to check whether the request provides a mapping between documents and services. For example, the mapping in the request may contain two separate lists, one with the EMDS and one the services, or may contain a list of associations between EMD and services like “EMD1-SRV1-2, EMD2-SRV3-4”.

If the EMD(s) is/are not explicitly defined or mentioned in the request in block 318, all the EMDs involved in the current context of the change are automatically identified by the service changer system 20 and retrieved by the service changer system 20 in block 320. The service changer system 20 transfers control to block 324.

In block 324, if the service changer system 20 does not find a mapping document in the request, the service changer system 20 transfers control block 326; otherwise, control is transferred to block 325. In block 325, the service changer system 20 performs a test to determine the validity of the mapping. If the mapping in the mapping document is not valid, the transaction is rejected (block 340). For example, several services can be requested to be included in the same exchange but, if these services don't have the same RFIC code, these services cannot be in the same pricing record, and the mapping is considered invalid. If the mapping in the mapping document is valid, the service changer system 20 transfers control to block 330.

If a mapping document is not provided in the input request received in block 326, the service changer system 20 determines its own mapping between EMDs and services mainly on the basis of passenger association. The service changer system 20 performs a test to determine whether a single mapping document can be selected for the current change context. If a single mapping document cannot be selected, the service changer system 20 transfers control to block 338 to determine whether the mapping operation can be determine at later stage of the exchange process. This could be the case, for example, if it is not possible to infer all exchanges from the PNR and have the pricing engines provide a feature to calculate the mapping based on amount balances. If the mapping cannot be postponed, the transaction is rejected (block 340); otherwise, the service changer system 20 transfers control to block 330.

If the test in block 326 does provide a single mapping document as the result, the service changer system 20 automatically determines the mapping document to be applied to the exchange request (block 328). In block 330, the service changer system 20 automatically retrieves the EMDs to be selected for the voluntary change request from the EMD database 230.

In block 332, the service changer system 20 performs a test to check the eligibility of each EMD retrieved in block 330 based on the predefined eligibility rules. For example, an EMD that has a coupon already on exchanged or reissued status is not eligible to current request of voluntary exchange. For an EMD that is not eligible, the transaction is rejected (block 340); otherwise, for eligible EMDs, the service changer system 20 transfers control to block 334. In block 334, the service changer system 20 prepares an updated PNR for each passenger. For instance, if previous pricing records are present in the existing PNR for the rebooked services, they are deleted. After the updated PNR is prepared for each passenger, the exchange process is continued in block 336.

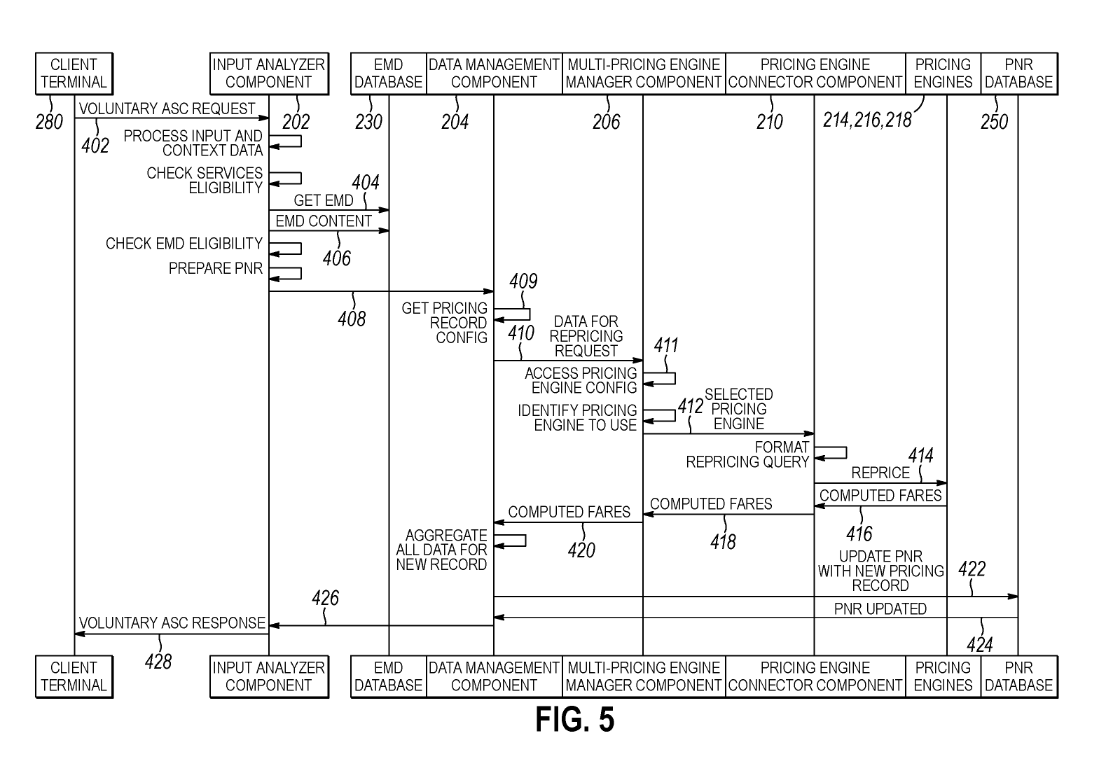

With reference to FIG. 5, a sequence diagram is shown to illustrate the ingoing and outgoing messages exchanged between the components in accordance with an embodiment of the invention. The sequence diagram plots the interactions between objects in the sequential order that those interactions occur.

In message 402, a request for a voluntary service change in receiving at the input analyzer component 202 of the service changer system 20. The content of the request is analyzed and eligibility of the request is checked by the service changer system 20 as detailed with reference to FIG. 4A. The input analyzer component 202 queries the EMD database 230 in message 404 to retrieve the EMD corresponding to the request. The data representing the EMD is sent back to the input analyzer component 202 in message 406. Upon receipt of the EMD data, the input analyzer component 202 finalizes the overall request checking process as described in FIG. 4B and prepares the PNR for pursuing the process.

The input analyzer component 202 provides the PNR data in message 408 to the data management component 204 of the service changer system 20. The data management component 204 is globally in charge of aggregating all data to perform the EMD exchange by operating the following sub-processes. The data management component 204 retrieves the configuration of the pricing record in message 409 from the pricing record configuration database 212. The data management component 204 sends a request to retrieve the repricing information in message 410 to the multi-pricing engine manager component 206. The multi-pricing engine manager component 206 retrieves the pricing engine selection rules from the pricing engine configuration database 208 in message 411 to identify which of the pricing engines 214, 216, 218 to query for the exchange. The multi-pricing engine manager component 206 is designed to handle the multiple existing situations to repricing services depending upon the airline industry because not all airlines provide prices for flights and ancillary services in the same way. Some airlines use the ATPCO filing, while other airlines locally store their pricing rules on their own servers and provide interfaces for the GDSs 12 to access the pricing rules.

The pricing engine selection rules and the PNR data are sent in message 412 from the multi-pricing engine manager component 206 to the pricing engine connector component 210 of the service changer system 20. The pricing engine connector component 210 is in charge of formatting a repricing query in the format required by each pricing engine interface. The pricing engine connector component 210 sends a query for repricing to at least one of the pricing engines 214, 216, 218 identified for repricing in message 414 and subsequently receives the computed fares from each pricing engine in message 416.

The computed fares are communicated in messages 418, 420 to the data management component 204, which is in charge of aggregating all data. After receiving the computed fares, the data management component 204 of the service changer system 20 has received the data used to fill a new pricing record from which the reissued EMD will be generated. The data management component 204 updates the PNR including the pricing record, as well as all the related fare elements used in issuance processing (original issue, endorsement, etc. . . . ). Besides the pricing record that will constitute the basis for the reissue EMD, a residual value record may be created, depending on the repricing output, by the data management component 204. The result will be a residual value EMD containing an amount, which is not used in the exchange, that can be returned to the passenger according to airline rules and practices. The PNR database 250 is updated with the new pricing record in message 422 and an acknowledgment is returned to the data management component 204 updates in message 424. The updated PNR is forwarded from the data management component 204 to the input analyzer in message 426, which then forwards the result of the voluntary change process to the client terminal 280 in message 428.

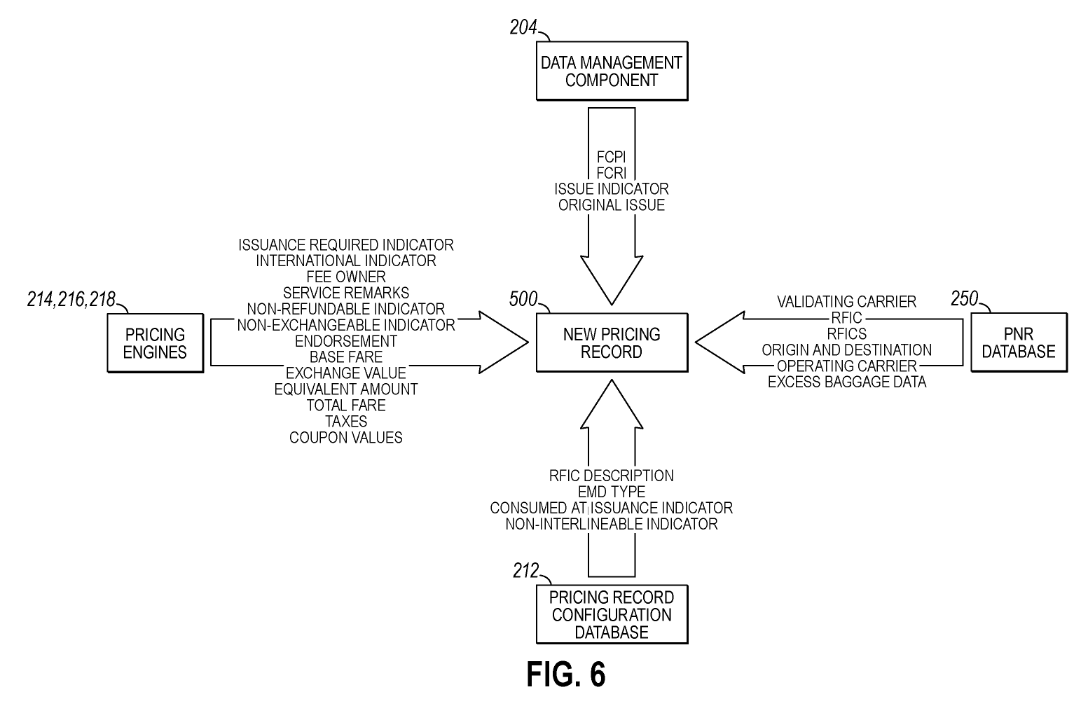

FIG. 6 illustrates the aggregation of all the data provided by the different components and databases to the data management component 204 for the creation of the new pricing record 500.

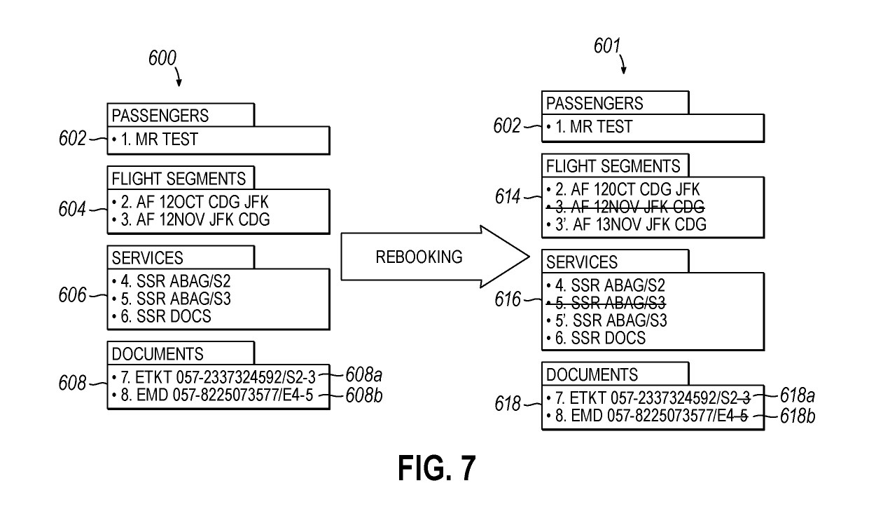

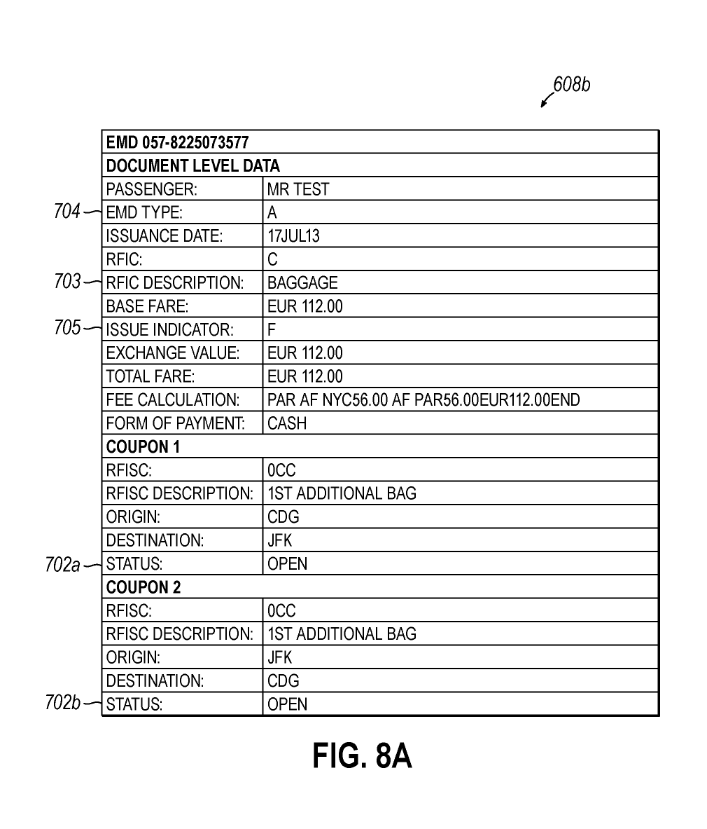

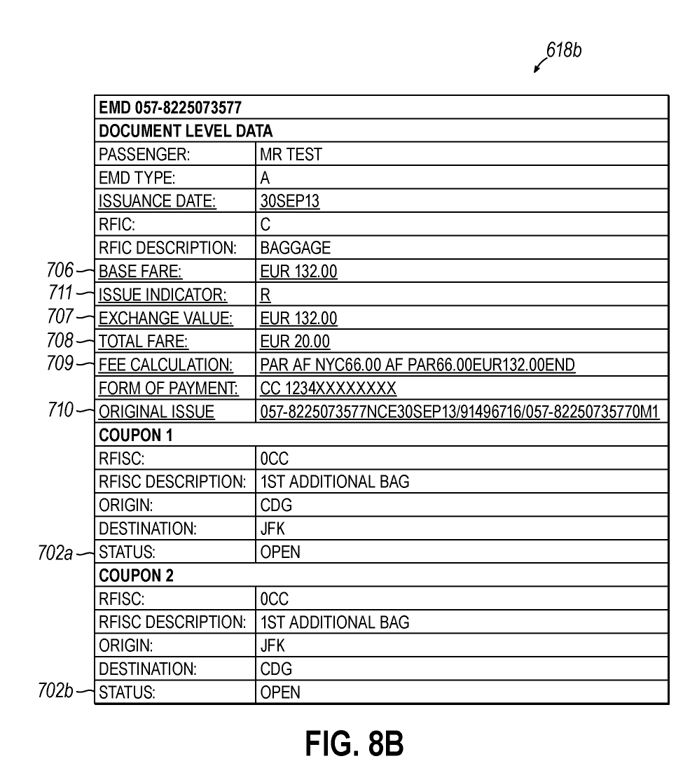

With reference to FIG. 7, an exemplary PNR is illustrated with the PNR 600 in existence before a rebooking involving a voluntary change and the PNR 601 following the rebooking. With reference to FIGS. 8A and 8B, respectively, an exemplary EMD 608b before processing of the change request associated with the voluntary change rebooking of FIG. 7 and the new exemplary EMD 618b after processing of the change request of FIG. 7 is illustrated.

Before the voluntary change request resulting in the rebooking, the fields or parts of a PNR 600 include a passenger (1.Mr. Test 602) who is reserved with flight segments 604 on a flight from Paris to New York on October 12 (2.AF 12OCT CDG JFK), with a return on November 12 (3.AF 12NOV JFK CDG). Ancillary services 606 are requested for an additional baggage for the whole itinerary under specific special service requests (4.SSR ABAG/S2) and (5.SSR ABAG/S3). The documents 608 generated for Mr. Test's booking are an e-ticket 608a (7.ETKT 057-2337324592/S2-3) for the flight and an EMD 608b (EMD 057-822073577/E4-5) for the services.

In the exemplary scenario, Mr. Test decides to extend his stay in New York for one day. As a result, Mr. Test contacts the airline agency to rebook a different flight for a new return date of November 13. The old flight and the service associated with the old flight are deleted from Mr. Test's reservation and they are replaced by a new flight (3′.AF 13NOV JFK CDG) with a different date and a new additional service 616 (5′.SSR ABAG/S3) for the baggage associated to this new flight. Other documents are still valid but they only apply to the portion of the itinerary that has not been rebooked. The agent has to exchange the old documents with the new reservation. The e-ticket is exchanged, and the EMD exchange is also performed.

To initiate the performance of the EMD exchange, the agent from his or her client terminal 280 (e.g., a cryptic terminal) displays the PNR of the customer as rebooked with the new itinerary. The agent sends an EMD exchange request using, for example, a cryptic command of the type ‘FXQ/EMD’, but no parameters are explicitly selected. The current PNR context (with passengers, flight segments, services and documents included in the reservation) is taken into account in the request. As already detailed, the input analyzer component 202 processes the context and identifies the following elements for the exchange. One element is the passenger, Mr. Test (1.Mr TEST), who is the only passenger in the PNR. Other elements are the special service requests (4.SSR ABAG/S2, 5′.SSR ABAG/S3) for ancillary services. While there is a third service in the PNR 600 (6.SSR DOCS), this service is set as non-chargeable and is considered non-eligible for the exchange. Another element is the EMD. Only one EMD (EMD 057-8225073577) is referenced in the PNR 600 for passenger 1.

It is necessary to verify the data contained in the EMD 608b (message 404 in FIG. 5). The EMD database 230 is queried to retrieve the entire EMD document so that its content can be analyzed to determine the conditions for its eligibility. The coupon status is verified. In the example shown on FIG. 8A, the EMD has two coupons 702a, 702b with an “open” status, which means that the EMD document is eligible for an exchange.

The configuration information for the considered service, i.e., for the additional baggage ‘ABAG’, is retrieved from the pricing record configuration database 212, which stores the pricing records configuration of different airlines. The configuration information may include a reason for issuance code (RFIC) description 703 that defines a group of services to which an EMD belongs. The configuration information may further include an EMD type 704, a consumed at issuance indicator 705, and a non-interlineable indicator. In FIG. 8A, the configuration information for the example of Mr. Test's EMD exchange includes BAGGAGE as the RFIC description 703, “A” (i.e., flight associated) as the EMD type 704, “F” (i.e., FALSE) as the consumed at issuance indicator 705, and FALSE as the non-interlineable indicator.

As already detailed, at this point of the exchange process, it is necessary to obtain all fare and amounts that will fill the new pricing record. The multi-pricing engine management component 206 accesses the pricing engine configuration database 208 to check which pricing engine is in charge of the repricing for the current context. In the example, for the considered airline and services, the selected pricing engine may be a pricing engine based on ATPCO filing.

The pricing engine selection and the current transaction data are forwarded to pricing engine connector component 210, which is the component of the service changer system 20 having the parameters corresponding to each specific interface of each pricing engine. In the exemplary embodiment, the pricing engine connector component 210 fills the repricing request with the necessary data according to the ATPCO pricing engine requirements, and then sends the request to the correct pricing engine and receives the computation results.

When the results from the pricing engine are received by the pricing engine connector, the results are adapted to a format independent of the pricing engine that has provided the results. As a result, data received from different pricing engines is uniformly handled by the pricing engine connector component 210 in the same way. The pricing data received from the pricing engine may include an issuance required flag, an international indicator, a fee owner, a non-refundable indicator, a non-exchangeable indicator, a base fare 706, an exchange value 707, and a total fare 708. For the example of Mr. Test's EMD exchange, the issuance required flag is TRUE, the international indicator is “I” (for international), the fee owner is Air France (AF), the non-refundable indicator is FALSE, the non-exchangeable indicator is FALSE, the base fare 706 is 132.00 EUR, the exchange value 707 is 132.00 EUR, and the total fare 708 is 20.00 EUR (which is the difference between the new price and the EMD amount).

The new pricing record is further populated with data computed by the data management module. For example, an issue indicator 711, original issue data 710, and FCPI (Fare Calculation Pricing Indicator) and FCRI (Fare Calculation Reporting Indicator) flags (not shown) are computed by the data management module. The original issue data 710 contains the reference to the exchanged EMD and coupons, as well as the exchange date, and the IATA number of the office. For the example of Mr. Test's EMD exchange, the issue indicator 711 is “R” for reissue, and the fare calculation pricing indicator (FCPI) and fare calculation reporting Indicator (FCRI) flags are both set to ‘0’ to indicate that the calculation is automatic because it comes from a pricing engine.

The exchange is finalized by updating the context with all of the data and information processed. Most of these data will be fields or parts of the new pricing record that will be used to generate the new EMD at issuance time. Some of the data can be stored in different elements of the PNR, but still with links to the main pricing record, such as the original issue or the endorsement. All these elements are created for the PNR and will be available at issuance for the new document preparation.

A response is returned to the agent to communicate the successful transaction. Then, the agent is able to check the output of the transaction with all computed amounts, and additional collection or penalty fees, if any. The issuance of the new EMD may be obtained without performing any other manual operation.

FIG. 8B shows the new exemplary EMD 618b issued for the example of Mr. Test's EMD exchange with all modifications and repricing information updated. The repricing information includes the base fare 706, the exchange value 707, the total fare 708, the fee calculation 709, and a link with the original issue data 710. The new e-ticket 618a (7.ETKT 057-2337324592/S2-3) for the flight is also present as a document in the PNR 601, as well as an EMD 608b (EMD 057-822073577/E4-5) for the services. The update to the flight segments 614 as a result of the re-ticketing is also apparent in the PNR 601.

Depending on the change request, the service changer system 20 may exchange several EMDs for each passenger and for several passengers at the same time. The service changer system 20 may be accessed through a flexible graphical user interface that offers clear and efficient entries to an agent to specify several exchange combinations that can be processed in one shot, thereby saving time. The service changer system 20 may offer an integrated solution, including all necessary checks of amounts and data, to allow that a transaction context is properly updated in order to provide agents and customers with clear visibility on the services being exchanged.

In general, the routines executed to implement the embodiments of the invention, whether implemented as part of an operating system or a specific application, component, program, object, module or sequence of instructions, or even a subset thereof, will be referred to herein as “computer program code,” or simply “program code.” Program code typically comprises one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution.

The program code embodied in any of the applications/modules described herein is capable of being individually or collectively distributed as a program product in a variety of different forms. In particular, the program code may be distributed using a computer readable media, which may include computer readable storage media and communication media. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

These computer program instructions may also be stored in a computer readable medium that can direct a computer, other types of programmable data processing apparatus, or other devices to function in a particular manner, such that the instructions stored in the computer readable medium produce an article of manufacture including instructions that implement the function/act specified in the block or blocks of the flowchart and/or block diagram.

The computer program instructions may also be loaded onto a computer, other programmable data processing apparatus, or another device to cause a series of computations to be performed on the computer, the other processing apparatus, or the other device to produce a computer implemented process such that the executed instructions provide one or more processes for implementing the functions/acts specified in the flowchart and/or block diagram block or blocks.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the present invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

1. A method of responding to a change in an airline reservation, the method comprising:
receiving a request for the change to the airline reservation at a computer system, the request comprising first data for a passenger name record;
receiving, at the computer system, second data for a first electronic miscellaneous document that is linked to the first data for the passenger name record;
determining, by the computer system, whether the first electronic miscellaneous document can be exchanged by applying at least one exchange eligibility rule to the first data for the passenger name record and the second data for the first electronic miscellaneous document;
if the first electronic miscellaneous document can be exchanged, obtaining a fare for a service associated with the first electronic miscellaneous document from a pricing engine associated with the first electronic miscellaneous document; and
in response to receiving the fare for the service, updating the passenger name record with a second electronic miscellaneous document including the fare for the service.

2. The method of claim 1 wherein receiving the second data for the first electronic miscellaneous document that is linked to the first data for the passenger name record comprises:
retrieving the second data for the first electronic miscellaneous document from an airline database.

3. The method of claim 1 wherein the first electronic miscellaneous document can be exchanged if the request includes a third electronic miscellaneous document, and the first and third electronic miscellaneous documents are handled by the same validating carrier.

4. The method of claim 1 wherein the first electronic miscellaneous document can be exchanged if the request does not include a third electronic miscellaneous document, and if the request does not include an indication of a flight disruption.

5. The method of claim 1 wherein the first electronic miscellaneous document can be exchanged if the request does not include a third electronic miscellaneous document, the request includes an indication of a flight disruption, and the first electronic miscellaneous document has a standalone designation, a validating carrier changes in the request, a number of coupons for services differs from a number of new services in the request, an airport changes in the request, an operating carrier changes in the request, or a flight segment reference is the same in the request.

6. The method of claim 1 further comprising:
updating the passenger name record with a link to the second electronic miscellaneous document.

7. The method of claim 6 wherein a pricing record for the second electronic miscellaneous document is built by aggregating elements from the first data of the passenger name record, elements from the second data of the first electronic miscellaneous document, the fare received from the pricing engine, and third data computed by the automatic processing.

8. The method of claim 1 wherein the service is automatically identified from a context of the request if the service is not mentioned in the request.

9. The method of claim 1 wherein the first electronic miscellaneous document is automatically identified from a context of the request if the first electronic miscellaneous document is not mentioned in the request.

10. A system for responding to a change in an airline reservation, the system comprising:
at least one processor; and
a memory coupled to the at least one processor, the memory including program code configured to be executed by the at least one processor to cause the system to:
receive a request for the change to the airline reservation, the request comprising first data for a passenger name record;
receive second data for a first electronic miscellaneous document that is linked to the first data for the passenger name record;
determine whether the first electronic miscellaneous document can be exchanged by applying at least one exchange eligibility rule to the first data for the passenger name record and the second data for the first electronic miscellaneous document; and
if the first electronic miscellaneous document can be exchanged, obtain a fare for a service associated with the first electronic miscellaneous document from a pricing engine associated with the first electronic miscellaneous document; and
in response to receiving the fare for the service, update the passenger name record with a second electronic miscellaneous document including the fare for the service.

11. The system of claim 10 wherein the program code configured to be executed by the at least one processor to cause the system to receive the second data for the first electronic miscellaneous document comprises:
program code configured to be executed by the at least one processor to cause the system to retrieve the second data for the first electronic miscellaneous document from an airline database.

12. The system of claim 10 wherein the program code is further configured to be executed by the at least one processor to cause the system to:
exchange the first electronic miscellaneous document if the request includes a third electronic miscellaneous document, and the first and third electronic miscellaneous documents are handled by the same validating carrier.

13. The system of claim 10 wherein the program code is further configured to be executed by the at least one processor to cause the system to:
exchange the first electronic miscellaneous document if the request does not include a third electronic miscellaneous document, and if the request does not include an indication of a flight disruption.

14. The system of claim 10 wherein the program code is further configured to be executed by the at least one processor to cause the system to:
exchange the first electronic miscellaneous document if the request does not include a third electronic miscellaneous document, the request includes an indication of a flight disruption, and the first electronic miscellaneous document has a standalone designation, a validating carrier changes in the request, a number of coupons for services differs from a number of new services in the request, an airport changes in the request, an operating carrier changes in the request, or a flight segment reference is the same in the request.

15. The system of claim 10 wherein the program code configured to be executed by the at least one processor to cause the system to update the passenger name record with the second electronic miscellaneous document including the fare for the service comprises:
program code configured to be executed by the at least one processor to cause the system to update the passenger name record with a link to the second electronic miscellaneous document.

16. The system of claim 15 wherein the program code is further configured to be executed by the at least one processor to cause the system to:
build a pricing record for the second electronic miscellaneous document by aggregating elements from the first data of the passenger name record, elements from the second data of the first electronic miscellaneous document, the fare received from the pricing engine, and third data computed by the automatic processing.

17. The system of claim 10 wherein the program code is further configured to be executed by the at least one processor to cause the system to:
automatically identify the service from a context of the request if the service is not mentioned in the request.

18. The system of claim 10 wherein the program code is further configured to be executed by the at least one processor to cause the system to:
automatically identify the first electronic miscellaneous document from a context of the request if the first electronic miscellaneous document is not mentioned in the request.

19. A computer program product comprising:
a non-transitory computer readable storage medium; and
program code stored on the computer readable storage medium and configured, upon execution, to cause at least one processor to:
receive a request for a change to an airline reservation, the request comprising first data for a passenger name record;
receive second data for a first electronic miscellaneous document that is linked to the first data for the passenger name record;
determine whether the first electronic miscellaneous document can be exchanged by applying at least one exchange eligibility rule to the first data for the passenger name record and the second data for the first electronic miscellaneous document; and
if the first electronic miscellaneous document can be exchanged, obtain a fare for a service associated with the first electronic miscellaneous document from a pricing engine associated with the first electronic miscellaneous document; and
in response to receiving the fare for the service, update the passenger name record with a second electronic miscellaneous document including the fare for the service.
